(19) United States
(12) Patent Application Publication
(10) Pub. No.: US 2014/0282818 A1
(43) Pub. Date: Sep. 18, 2014

(54) ACCESS CONTROL IN A SECURED CLOUD ENVIRONMENT

(71) Applicant: FortyCloud Ltd., (US)

(72) Inventors: Noam Singer, Kibbutz Einat (IL); Amir Naftali, Kiryot Ono (IL)

(73) Assignee: FortyCloud Ltd., Nes Ziyona (IL)

(21) Appl. No.: 13/827,400

(22) Filed: Mar. 14, 2013

(51) Int. Cl. G06F 21/62

(52) U.S. Cl. CPC G06F 21/6218
USPC 726/1

(57) ABSTRACT

The disclosure presents systems, methods and computer program products relating to access control in a secured network. An access control policy may be indicated which at least includes a first entity being allowed to access a second entity, by way of at least one protocol via a secured network. The policy may be translated by at least one gateway or server in the secured network into firewall rule(s) to control access in the secured network.

### TECHNICAL FIELD

The disclosure relates to overlay networks.

### BACKGROUND

An overlay network may be a computer network which may be built on top of an underlying network such as the Internet. Overlay networks on top of the Internet have been built or proposed in order to permit routing of messages to destinations not specified by an IP address or to connect between separate networks.

### SUMMARY

In accordance with the presently disclosed subject matter, there is provided a method of controlling access in a secured network, comprising: accessing management software on a management machine and indicating a policy which at least includes a first entity being allowed to access a second entity, by way of at least one protocol via the secured network; thereby enabling the management machine to provide the policy to at least one machine in the secured network, and at least one of the at least one machine to translate the policy into at least one firewall rule to control access in the secured network.

In some embodiments of the method, the policy at least also includes an entity being allowed to access another entity at least partly via an unsecured network.

In some embodiments of the method, the management software is provided as a service in a cloud environment.

In some embodiments, the method enables provisioning of at least one of: broad network access or on-demand self service to a user associated with the device.

In some embodiments of the method, the secured network is an overlay network in a cloud environment.

In accordance with the presently disclosed subject matter, there is provided a method of controlling access in a secured network, comprising: providing a policy which at least includes a first entity being allowed to access a second entity, by way of at least one protocol via the secured network, to at least one machine in the secured network; thereby enabling at least one of the at least one machine to translate the policy into at least one firewall rule to control access in the secured network.

In some embodiments of the method, the policy also at least includes an entity being allowed to access another entity at least partly via an unsecured network.

In some embodiments of the method, the second entity includes at least one server provided by a cloud provider.

In some embodiments of the method, the first entity includes at least one user and the policy is at least provided to a gateway by way of which at least one device associated with at least one user included in the first entity is allowed to access at least one server included in the second entity.

In some embodiments of the method, the first entity includes at least one server, and the policy is at least provided to at least one gateway by way of which at least one server included in the first entity is allowed to access at least one server included in the second entity.

In some embodiments of the method, the first entity includes at least one server, and the policy is at least provided to at least one server included in the second entity.

In some embodiments of the method, the secured network includes a plurality of machines with respective firewalls.

In accordance with the presently disclosed subject matter, there is provided a method of controlling access in a secured network, comprising: receiving a policy relating to access control in the secured network; translating the policy into at least one firewall rule; and allowing or not allowing access via the secured network by a device associated with a user authorized for the secured network, or by a server, based on the at least one firewall rule.

In some embodiments of the method, the policy relates to access from outside the secured network, the method further comprising: when a device associated with a user not authorized for the secured network attempts access to a server at least partly via an unsecured network, allowing or not allowing access based on the at least one firewall rule.

In some embodiments of the method, translating the policy into at least one firewall rule applicable for a particular user is performed by a gateway when a device associated with the user accesses the gateway.

In accordance with the presently disclosed subject matter, there is provided a method of controlling access in a secured network, comprising: a device associated with a user accessing a gateway in the secured network; thereby causing the gateway to translate a policy applicable to the user into at least one firewall rule and to allow or not allow access to one or more servers in the secured network based on the at least one firewall rule.

In some embodiments of the method, at least one of the one or more servers is provided by at least one cloud provider, and the method enables provisioning of at least one of: broad network access or on-demand self service to the user.

In accordance with the presently disclosed subject matter, there is provided a system for controlling access in a secured network, comprising a device capable of accessing management software on a management machine and indicating a policy which at least includes a first entity being allowed to access a second entity, by way of at least one protocol via the secured network; thereby enabling the management machine to provide the policy to at least one machine in the secured network, and at least one of the at least one machine to translate the policy into at least one firewall rule to control access in the secured network.

In accordance with the presently disclosed subject matter, there is provided a system for controlling access in a secured network, comprising a management machine capable of providing a policy which at least includes a first entity being allowed to access a second entity, by way of at least one protocol via the secured network, to at least one machine in the secured network; thereby enabling at least one of the at least one machine to translate the policy into at least one firewall rule to control access in the secured network.

In accordance with the presently disclosed subject matter, there is provided a system for controlling access in a secured network, the system comprising a gateway or server capable of: receiving a policy relating to access control in the secured network; translating the policy into at least one firewall rule; and allowing or not allowing access via the secured network by a device associated with a user authorized for the secured network, or by a server, based on the at least one firewall rule.

In accordance with the presently disclosed subject matter, there is provided a system for controlling access in a secured network, comprising a device associated with a user capable of accessing a gateway in the secured network; thereby causing the gateway to translate a policy applicable to the user into at least one firewall rule and to allow or not allow access to one or more servers in the secured network based on the at least one firewall rule.

In accordance with the presently disclosed subject matter, there is provided a computer program product comprising a machine useable medium having machine readable program code embodied therein for controlling access in a secured network, the computer program product comprising: machine readable program code for causing a machine to access management software on a management machine and to indicate a policy which at least includes a first entity being allowed to access a second entity, by way of at least one protocol via the secured network; thereby enabling the management machine to provide the policy to at least one machine in the secured network, and at least one of the at least one machine to translate the policy into at least one firewall rule to control access in the secured network.

In accordance with the presently disclosed subject matter, there is provided a computer program product comprising a machine useable medium having machine readable program code embodied therein for controlling access in a secured network, the computer program product comprising: machine readable program code for causing a machine to provide a policy which at least includes a first entity being allowed to access a second entity, by way of at least one protocol via the secured network, to at least one machine in the secured network; thereby enabling at least one of the at least one machine to translate the policy into at least one firewall rule to control access in the secured network.

In accordance with the presently disclosed subject matter, there is provided a computer program product comprising a machine useable medium having machine readable program code embodied therein for controlling access in a secured network, the computer program product comprising: machine readable program code for causing a machine to receive a policy relating to access control in the secured network; machine readable program code for causing the machine to translate the policy into at least one firewall rule; and machine readable program code for causing the machine, to allow or not allow access via the secured network by a device associated with a user authorized for the secured network, or by a server, based on the at least one firewall rule.

In accordance with the presently disclosed subject matter, there is provided a computer program product comprising a machine useable medium having machine readable program code embodied therein for controlling access in a secured network, the computer program product comprising: machine readable program code for causing a machine associated with a user to access a gateway in the secured network; thereby causing the gateway to translate a policy applicable to the user into at least one firewall rule and to allow or not allow access to one or more servers in the secured network based on the at least one firewall rule.

### BRIEF DESCRIPTION OF THE DRAWINGS

In order to understand the subject matter and to see how it may be carried out in practice, non-limiting embodiments will be described, with reference to the accompanying drawings, in which:

FIG. 1 illustrates a network for controlling access in a secured network, in accordance with some embodiments of the presently disclosed subject matter; and

FIG. 2 (comprising FIG. 2A and FIG. 2B) illustrates a method of translating policies into firewall rules, in accordance with some embodiments of the presently disclosed subject matter.

FIG. 3 illustrates an abstraction module relating to access control, in accordance with some embodiments of the presently disclosed subject matter;

FIG. 4 illustrates a graphical representation of policies relating to access control, in accordance with some embodiments of the presently disclosed subject matter;

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate identical or analogous elements.

### DETAILED DESCRIPTION OF THE DRAWINGS

In the following detailed description, numerous specific details are set forth in order to provide a thorough understanding of the subject matter. However, it will be understood by those skilled in the art that some examples of the subject matter may be practiced without these specific details. In other instances, well-known features, structures, stages, methods, modules, elements, and systems have not been described in detail so as not to obscure the subject matter.

Usage of terms “normally”, “typically although not necessarily”, “although not necessarily so” “such as”, “e.g.”, “possibly”, “it is possible”, “optionally”, “say”, “one embodiment”, “embodiments”, “an embodiment”, “some embodiments”, “various embodiments”, “other embodiments”, “certain embodiments”, “some other embodiments”, illustrated embodiments”, “another embodiment”, “for example” “one example”, “an example” “some examples”, “examples”, “another example”, “various examples”, “other examples”, “for instance”, “an instance”, “one instance”, “some instances”, “another instance”, “other instances”, “various instances” “one case”, “cases”, “some cases”, “another case”, “other cases”, “various cases”, or variants thereof should be construed as meaning that a particular described feature, structure, stage, method, module, element, or systems is included in at least one non-limiting embodiment of the subject matter, but not necessarily in all embodiments. The appearance of the same term does not necessarily refer to the same embodiment(s).

The term “illustrated embodiments”, is used to direct the attention of the reader to one or more of the figures, but should not be construed as necessarily favoring any embodiments over any other.

Usage of conditional language, such as “may”, “can”, “could”, or variants thereof should be construed as conveying that one or more embodiments of the subject matter may include, while one or more other embodiments of the subject matter may not necessarily include, certain features, structures, stages, methods, modules, elements, or systems. Thus such conditional language is not generally intended to imply that a particular described feature, structure, stage, method, module, element, or system is necessarily included in all embodiments of the subject matter.

Usage of the term “or” should be construed to mean “and/or” unless expressly indicated otherwise, or unless incorrect for a particular context.

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

As used herein terms such as “processing”, “calculating”, “determining”, “generating”, “establishing”, “changing”, “accessing”, “determining”, “allowing”, “enabling” “providing”, “translating”, “controlling”, “provisioning”, “building”, “receiving”, “attempting”, “causing”, “disallowing”, “routing” “joining”, “logging”, “configuring”, “performing”, “executing”, or the like should be construed as referring to the action(s) or process(es) of any combination of software, hardware or firmware. For example, although not necessarily so, these terms may refer to the action(s) or process(es) of one or more machine(s) specially constructed for the desired purposes, or one or more general purpose machine(s) specially configured for the desired purposes by program code stored in a machine readable medium. The action(s) or process(es) may, for instance, manipulate or transform data represented as physical, such as electronic quantities, within the register(s) or memory/ies of the machine(s) into other data similarly represented as physical quantities within the memory/ies, register(s) or other such information storage, transmission or display element(s) of the machine(s). The term machine should be expansively construed to cover any kind of virtual or physical machine which may have data processing capabilities and which may be made up of any combination of hardware, software or firmware that includes at least some hardware. Examples of such a machine may include: a user device (e.g. personal computer, laptop, communication device, smartphone, etc), an input/output device (e.g. mouse, keyboard, screen, touchscreen, etc), a gateway, a server (e.g. web server, database server, application server, etc), a management machine etc.

Embodiments of the presently disclosed subject matter relate to access control in a secured network. A secured network may be secured, for instance, in any of the following ways: packets may be encrypted, packets may be authenticated, packets may be less likely to be intercepted or forged, unapproved traffic from outside the secured network may be prevented, etc.

In some embodiments, the secured network may be an overlay network, such as described in co-pending application “Dynamic secured network in a cloud environment”, inventors: Noam Singer and Amir Naftali filed on even date herewith, which is hereby incorporated by reference herein. In some other embodiments, the secured network may be any secured network. In these embodiments the secured network may or may not be an overlay network, and may or may not relate to cloud computing. In order for the reader to better understand embodiments where the secured network may relate to cloud computing, cloud computing will now be described.

Cloud computing is a model for enabling ubiquitous, convenient, on-demand network access to a shared pool of configurable computing resources (e.g., networks, servers, storage, applications, and services) that can be rapidly provisioned and released with minimal management effort or service provider interaction. This cloud model comprises at least five characteristics, at least three service models, and at least four deployment models.

Characteristics may include the following:

On-demand self-service. A consumer can unilaterally provision computing capabilities, such as server time and network storage, as needed automatically without requiring human interaction with each service provider.

Broad network access. Capabilities are available over the network and accessed through standard mechanisms that promote use by heterogeneous thin or thick client platforms (e.g., mobile phones, tablets, laptops, and workstations).

Resource pooling. The provider's computing resources are pooled to serve multiple consumers using a multi-tenant model, with different physical and virtual resources dynamically assigned and reassigned according to consumer demand. There is a sense of location independence in that the customer generally has no control or knowledge over the exact location of the provided resources but may be able to specify location at a higher level of abstraction (e.g., country, state, or datacenter). Examples of resources include storage, processing, memory, and network bandwidth.

Rapid elasticity. Capabilities can be elastically provisioned and released, in some cases automatically, to scale rapidly outward and inward commensurate with demand. To the consumer, the capabilities available for provisioning often appear to be unlimited and can be appropriated in any quantity at any time.

Measured service. Cloud systems automatically control and optimize resource use by leveraging a metering capability (typically on a pay-per-use or charge-per-use basis) at some level of abstraction appropriate to the type of service (e.g., storage, processing, bandwidth, and active user accounts). Resource usage can be monitored, controlled, and reported, providing transparency for both the provider and consumer of the utilized service.

Service Models may include the following:

Software as a Service (SaaS). The capability provided to the consumer is to use the provider's applications running on a cloud infrastructure. The applications are accessible from various client devices through either a thin client interface, such as a web browser (e.g., web-based email), or a program interface. The consumer does not manage or control the underlying cloud infrastructure including network, servers, operating systems, storage, or even individual application capabilities, with the possible exception of limited user-specific application configuration settings.

Platform as a Service (PaaS). The capability provided to the consumer is to deploy onto the cloud infrastructure consumer-created or acquired applications created using programming languages, libraries, services, and tools supported by the provider. The consumer does not manage or control the underlying cloud infrastructure including network, servers, operating systems, or storage, but has control over the deployed applications and possibly configuration settings for the application-hosting environment. This capability does not necessarily preclude the use of compatible programming languages, libraries, services, and tools from other sources

Infrastructure as a Service (IaaS). The capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, and deployed applications; and possibly limited control of select networking components (e.g., host firewalls).

Deployment Models may include the following:

Private cloud. The cloud infrastructure is provisioned for exclusive use by a single organization comprising multiple consumers (e.g., business units). It may be owned, managed, and operated by the organization, a third party, or some combination of them, and it may exist on or off premises.

Community cloud. The cloud infrastructure is provisioned for exclusive use by a specific community of consumers from organizations that have shared concerns (e.g., mission, security requirements, policy, and compliance considerations). It may be owned, managed, and operated by one or more of the organizations in the community, a third party, or some combination of them, and it may exist on or off premises.

Public cloud. The cloud infrastructure is provisioned for open use by the general public. It may be owned, managed, and operated by a business, academic, or government organization, or some combination of them.

Hybrid cloud. The cloud infrastructure is a composition of two or more distinct cloud infrastructures (private, community, or public) that remain unique entities, but are bound together by standardized or proprietary technology that enables data and application portability (e.g., cloud bursting for load balancing between clouds).

As mentioned above, conventionally a firewall may typically although not necessarily be deployed in order to secure a network or a machine in an environment where on at least one side of the firewall there is an unsecured network. For instance, a conventional firewall may be physical, meaning that there is no physical connection between the secured network or machine and the unsecured network that does not pass via the firewall. In embodiments of the presently disclosed subject matter, one or more firewall(s) may be deployed in order to enable access control in a secured network. Any deployed firewall may be software or hardware based, depending on the embodiment.

Referring now to the figures, FIG. 1 illustrates a network 100 for controlling access in a secured network, in accordance with some embodiments of the presently disclosed subject matter.

In the illustrated embodiment, network 100 includes the following machines: one or more management machine(s) 110, one or more (input or user) device(s) 120 (x≧1), one or more user device(s) 140 (m≧1), one or more gateway(s) 130 (y≧1), one or more user device(s) 170 (z≧1), one or more server(s) 150 (n≧1). For any two connected machines in network 100 the connection may be physical (layer) or logical, depending on network 100. Although device(s) 120, device(s) 140, and device(s) 160 are illustrated separately, in some embodiments one or more devices may provide functionality ascribed herein to two or more of devices 120, 140, and 170. In some embodiments, there may be zero devices 120, zero devices 140, or zero devices 170 in network 100, however for the purpose of illustration only it is assumed in the discussion of FIG. 1 that there is at least one device 120, one device 140, and one device 170 in network 100.

Depending on the embodiment, one or more of management machine 110, gateway(s) 130, or server(s) 150 may be in one or more clouds, or none of management machine, gateway 130 and machines 150 may be in a cloud. In embodiments with at least one machine in a cloud, a machine in a cloud may also be referred to herein as a machine provided by a cloud provider. A “cloud provider” may refer to a provider in accordance with any cloud computing service model, such as described above. Depending on the embodiment, a “cloud” may refer to a public cloud or any other type of cloud described above.

In some embodiments with machine(s) in cloud(s), device(s) 120, 140, or 170 (which may be standard device(s)) may be capable of accessing machine(s) in cloud(s), as needed and automatically. Therefore in some cases of these embodiments, the subject matter may allow user(s) to take advantage of the broad network access or on-demand self service characteristics of cloud computing.

For the purpose of illustration only management machine 110 is illustrated and described. However reference to management machine 110 in the single form should be construed to refer to embodiments where there is one management machine or embodiments where there is a plurality of management machines, as appropriate. Management machine 110 may be concentrated in one location, or may be dispersed over more than one location. For instance, in embodiments where management machine 110 is described as being included in a cloud, management machine 110 may be concentrated in one cloud, may be dispersed over one cloud, or may be dispersed over a plurality of clouds. Communication between management machine 280 and gateway(s) 130 or server(s) 150 may be via any secure protocol such as Hypertext Transfer Protocol Secure (HTTPS).

Each of management machine 110, gateway(s) 130 and server(s) 150 may be made up of any combination of software, firmware or hardware capable of performing the operations as defined and explained herein. Although not necessarily so, in some embodiments any of management machine 110, gateway(s) 130, and server(s) 150 may include management software 112, gateway software and agent software respectively, including program code written in any appropriate programming language which may be capable of configuring management machine 110, gateway(s) 130 and machine(s) 150 respectively for the desired purposes (e.g. to perform operations defined and explained herein). Additionally or alternatively, in some embodiments any of management machine 110, gateway(s) 130, and server(s) 150 may include any combination of software, hardware or firmware conventionally found in a machine.

In embodiments where management machine 110 is in a cloud, then depending on the embodiment, management software 112 relating to the subject matter may or may not be provided as a service in a cloud environment.

Any device 120 may be capable of accessing management software 112 in management machine 110 in order to indicate access control policy as will be described in more detail below. For instance, device 120 may communicate with management machine 110 via a protocol such as the Hypertext Transfer Protocol (HTTP) or HTTPS. Management machine 110 may provide newly established or updated policy to all gateway(s) 130 and server(s) 150, or may provide newly established or updated policy to gateway(s) or server(s) for which the newly established or updated policy is relevant. The policy may be translated, as relevant, by gateway(s) 130 or server(s) 150 into firewall rules.

The terms policy, policies, part of policy, or variants thereof are used inter-changeably herein, and therefore what is termed policy may alternatively be termed part of policy, or vice versa, what is termed policy may alternatively be termed policies, or vice versa, what is termed part of policy may alternatively be termed policies, or vice versa, etc.

In the illustrated embodiments, a secured network 160 may include user device(s) 140, gateway(s) 130, and server(s) 150. User device(s) 140 may connect to gateway(s) 130 in order to access server(s) 150. Each server may connect to another server via one or more gateway(s) 130 or not via any gateway(s) 130. For instance, FIG. 1 shows a broken line connecting servers 150 to illustrate that there may or may not be a connection between any two servers 150 that is not via gateway(s). Network 160 may be secured by any appropriate means, including tunneling, firewalls, etc. For instance in the illustrated embodiment, each gateway or server in secured network 160 may include a respective firewall 135 or 155.

In the illustrated embodiments, user device(s) 170 are not shown as included in secured network 160. However, devices(s) 170 may or may not be allowed access from outside the secured network (at least partly by way of an unsecured network) to one or more server(s) 150 in secured network 160.

Rules for any firewall 135 associated with any gateway 130 may relate, for instance, to access by user device(s) 140 to various server(s) 150 depending on the server(s) or depending on the user(s) associated with the device(s) which may be authorized for the secured network. Additionally or alternatively for instance, rules for any firewall 135 associated with any gateway 130 may relate, for instance, to access between server(s) via the associated gateway 130, depending on the server(s). Additionally or alternatively, rules for any firewall 155 associated with any server 150 may relate, for instance, to direct access (not via any gateway 130) by other server(s) 150 to that server 150, depending on the server(s). Additionally or alternatively, rules for any firewall 155 associated with any server 150 may relate for instance to access by user device(s) 140 or other server(s) 150 via the gateway, e.g. where all traffic routed via the gateway may be allowed regardless of origin because it may be assumed that the traffic was filtered by the gateway. Additionally or alternatively, for instance, rules for any firewall 155 associated with any server 150 may relate to access from outside the secured network, such as access by user device(s) 170 over allowed port(s) for instance via HTTP, depending on the associated user(s) who may not be authorized for secured network 160 but who may be approved for access from outside the secured network.

For the purpose of illustration only, only one gateway 130 is illustrated in FIG. 1, but depending on the embodiment there may be one or more gateway(s) in network 100, each associated with (e.g. connected to) one or more servers. In embodiments with a plurality of gateways, firewalls 135 may include rules relating to access to any server 150 in secured network 100, or each firewall 135 corresponding to a gateway 130 may include rules relating to access to any server 150 in secured network 100 which is associated with the corresponding gateway.

The subject matter is not bound by any particular topology of network 100 or network 160 and in other embodiments, the topology may be slightly or substantially different than described and illustrated herein.

FIG. 2 illustrates a method of translating policies into firewall rules, in accordance with some embodiments of the presently disclosed subject matter.

In the illustrated embodiments in stage 204, device 120 may indicate a policy relating to access control in a secured network such as network 160. For simplicity of description, it is assumed in the description of method 200 that the secured network is secured network 160. Device 120 may indicate the policy, for instance, by accessing management software in management machine 110. The indicated policy may be a newly established policy or may be an updated policy.

Depending on the embodiment a newly established policy may be indicated when a secured network 160 is established, when access control is instituted for secured network 160 (if after establishment), or at any other stage.

Depending on the embodiment, the access control policy may be updated based on one or more triggers such as change in topology of secured network 160 (e.g. addition or removal of server(s) or gateway(s), addition, change or removal of connection(s)), change in characteristics of connection(s), change in networking characteristics of server(s) or gateway(s), addition or removal of user(s), change(s) in identifier(s) for server(s) or user(s) (e.g. role, Internet Protocol (IP) address), change(s) in which type(s) of access are considered desirable, change(s) in which type(s) of access are not considered desirable, other change(s) which may affect policy, time-dependent trigger(s), etc.

Although the subject matter is not bound by a particular policy, for the purpose of illustration only, an example is now provided. The indicated policy, for example, may at least include a first entity being allowed to access a second entity by way of at least one protocol via secured network 160. Depending on the embodiment, the indicated policy may or may not relate to access from outside the secured network. For instance the indicated policy may or may not at least also include an entity being allowed to access another entity at least partly via an unsecured network.

Stage 204 will be discussed in more detail with reference to FIGS. 3 and 4.

In the illustrated embodiments in stage 208, management machine 110 may provide (e.g. by securely distributing) the (newly established or updated) policy to at least one machine in secured network 160. For instance the policy may be provided to all server(s) 150 and gateway(s) 130 in secured network 160, or not necessarily to all, for instance if the policy is not relevant to certain server(s) 150 or gateway(s) 130. For instance, an updated policy may not be relevant to a particular server or gateway if the updated policy is no different than the previous policy for the particular server or gateway. Depending on the embodiment, management machine 110 may provide access control policy applicable to (authorized) users whose associated devices may connect via gateway(s) to one or more gateway(s) 130 at this stage, or may provide policy applicable to an authorized user as needed, for instance when a device 140 associated with the authorized user is attempting to join the secured network.

For instance refer again to the example where the access control policy may at least include a first entity being allowed to access a second entity by way of at least one protocol via secured network 160. If the first entity includes at least one (authorized) user, the policy may be at least provided to a gateway by way of which at least one device associated with at least one (authorized) user included in the first entity may be allowed to access at least one server included in the second entity. If the first entity includes at least one server, the policy may be at least provided to at least one gateway by way of which at least one server included in the first entity may be allowed to access at least one server included in the second entity, or may be at least provided to at least one server included in the second entity (e.g. which may be directly accessed by any server(s) included in the first entity).

In the illustrated embodiments in stage 212, a server 150 or gateway 130 which receives the policy may translate the policy into firewall rule(s) for implementing the policy, however not necessarily with regard to authorized users. For instance, a given firewall 135 or 155 may be an internal or external firewall (e.g. based on IPtables or any other internal or external firewall technology). (In some embodiments, an external firewall may not be relevant, for instance if data is encrypted). The given firewall 135 or 155 may operate based on IP addresses and therefore the policy (e.g. with respect to entity/ies) may be translated into rule(s) based on IP address(es). Translation into rule(s) may include comparing each possible rule to policy, retaining if conforming to policy, and discarding if not conforming to policy. Alternatively, optimization of translation into rules may be performed. For instance, an example of pseudo code for optimization of rule translation is provided in the Appendix. The subject matter is not bound by the optimization represented by this pseudo code.

Although not necessarily so, in some embodiments where the policy (e.g. with respect to entity/ies) may not be specified in terms of IP address(es), then in order to translate the policy into rules based on IP addresses, a server 150 or gateway 130 which receives the policy may need to determine the relevant IP address(es). In some of these embodiments, each server 150 or gateway 130 in secured network 160 may be aware of the IP address(es) of all server(s) 150 and gateway(s) 130 in secured network 160 and therefore may be capable of determining the relevant IP address(es) for the policy. For instance, if the policy specifies “web servers” and server 150 or gateway 130 is aware of the IP address(es) of all of the web server(s) in secured network, then server 150 or gateway 130 may determine that the IP address(es) of all of the web server(s) are relevant to the policy. Although not necessarily so, in some embodiments, management machine 110 may receive from each server 150 or gateway 130 data relating to the server or gateway including one or more IP address(es) of the server or gateway. Additionally or alternatively to the received IP address(es), management machine 110 may allocate IP address(es) to one or more server(s) or gateway(s) in secured network 150. Management machine 110 may provide (e.g. by securely distributing) to all server(s) and gateway(s) in secured network 160, data relating to all server(s) and gateway(s) in the network including IP address(es). In other embodiments, data may be received by management machine 110 from fewer than all server(s) and gateway(s). Additionally or alternatively, in other embodiments not all data may be provided by management machine 110 to all server(s) and gateway(s). Depending on the embodiment, data may be received by management machine 110 at any point and at any level of recurrence (e.g. time dependent, event dependent, etc) and data may be distributed by management machine 110, at any point and at any level of recurrence (e.g. time dependent, event dependent, etc).

In the illustrated embodiments in stage 216, a device 140 (associated with a user authorized for secured network 160) may attempt to join secured network 160 by accessing one or more gateway(s) 130 in secured network 160. For simplicity's sake, access to one gateway 130 by device 140 will be assumed in the description of stages 216 to 229. For instance device 140 may access gateway 130 by providing a username and password of the associated user. In the illustrated embodiments, the timing of stage 216 may be independent of stage 212 and therefore there is no arrow in FIG. 2 between the stages.

In the illustrated embodiments in stage 220, accessed gateway 130 may translate an access control policy applicable to the user associated with device 140 into firewall rule(s) (for implementing the policy) that may be applicable to the user. As mentioned above, corresponding firewall 135 may be an internal or external firewall (e.g. based on IPtables or any other internal or external firewall technology). (As noted above, in some embodiments, an external firewall may not be relevant, for instance if data is encrypted). Corresponding firewall 135 may operate based on IP address(es) and therefore a policy applicable to a user may be translated into firewall rule(s) based on an IP address associated with device 140 (where the IP address may or may not be assigned by accessed gateway 130).

In some embodiments, policy applicable to the user may not have been indicated in stage 204 based on an IP address, but rather based on other identifier(s) such as username or user group. The IP address associated with a user may not stable, for instance because a user may log in using different devices or from different locations, or because the IP address may be assigned by the gateway. Therefore a policy applicable to the user may not have been defined with reference to any IP address.

Translation of policy into firewall rules may include comparing each possible rule to policy, retaining if conforming to policy, and discarding if not conforming to policy. Alternatively, optimization of translation into rules may be performed. For instance, an example of pseudo code for optimization of rule translation is provided in the Appendix. The subject matter is not bound by the optimization represented by this pseudo code.

Depending on the embodiment, gateway 130 may request at this stage policy applicable to the user from management machine 110, or the policy provided in stage 208 may have covered applicable policy for the user. For instance, the policy provided in stage 208 may have covered applicable policy to the user in order to expedite stage 220.

Gateway 130 may determine that an access control policy is applicable to a user in any appropriate way, and therefore may be translated into firewall rule(s) applicable to the user. For instance a policy may specify a unique identifier of the user (e.g. username). If a policy, for instance, specifies a user group (rather than a unique identifier of the user), gateway 130 may determine that the user is included in the user group inherently (e.g. if the group includes all users), by way of communication with a machine which is aware of the inclusion of the user in the user group (e.g. device 140 or management machine 110), due to previously received data regarding the inclusion of the user in the user group (e.g. from management machine), etc. Additionally or alternatively, gateway 130 may determine that a policy is applicable to a user, for instance, if gateway 130 requested applicable policy from management machine 110 during stage 220.

In the illustrated embodiments, in stage 222, device 140 may attempt to access server1 150 via accessed gateway 130.

In the illustrated embodiments, in stage 224, accessed gateway 130 may or may not allow device 140 to access server1 150, depending on access control rules in firewall 135. If allowed, then in the illustrated embodiments in stage 228, gateway 130 may route data packets between device 140 and server1 150 via secured network 160. In the illustrated embodiments in stage 229, server1 may allow access to packets routed via gateway 130. In the illustrated embodiments, method 200 may end for device 140 if gateway 130 does not allow access or after routing is completed. Depending on the embodiment, at this stage accessed gateway 130 may or may not discard firewall rule(s) based on access control policy applicable to the authorized user associated with device 140 (and not applicable to any other user currently logged on).

Additionally or alternatively, in the illustrated embodiments, stages 232 to 238 may occur at any time, and not necessarily in relation to any device 140 attempting to access a server. Therefore there is no arrow shown in FIG. 2 between the previous stages and stage 232. A server may request access to another server for any reason. For instance, one server (e.g. mail server) may store data on another server (e.g. database server). In the illustrated embodiments, in stage 232, server1 150 may attempt to directly access server2 150 (not via any gateway). In the illustrated embodiments in stage 238, server2 150 may or may not allow access by server1 150 depending on access control rules in respective firewall 155. Additionally or alternatively, in the illustrated embodiments in stage 234, server2 150 may attempt to directly access server1 150. In the illustrated embodiments in stage 236, server1 may or may not allow access by server2 150 depending on access control rules in respective firewall 155.

Additionally or alternatively, in the illustrated embodiments, stages 240 to 246 may occur at any time, and not necessarily in relation to any device 140 attempting to access a server. Therefore there is no arrow shown in FIG. 2 between the previous stages and stage 240. In the illustrated embodiments in stage 240 a server such as server1 150 may attempt to access another server such as server2, via one or more gateways(s) 130. In the illustrated embodiments in stage 242, access may or may not be allowed by gateway(s) 130 depending on access control rules (relating to access between server(s)) in firewall(s) 135. If allowed, then in the illustrated embodiments in stage 244 gateway(s) 130 may route data packets between server1 150 and server2 150 via secured network 160. In the illustrated embodiments in stage 246, server2 150 may allow access to packets from server1 150 routed via gateway(s) 130.

Additionally or alternatively, in the illustrated embodiments stages 250 to 252 may occur at any time. Therefore there is no arrow shown in FIG. 2 between the previous stages and stage 250. In stage 250, device 170 associated with a user who may not be authorized for the secured network may attempt to access server1 150 in network 160 at least partly via an unsecured network. For instance, the access may not be via any gateway 130. In the illustrated embodiments in stage 252, server1 150 may or may not allow access depending on access control rules in respective firewall 155.

In the illustrated embodiments, method 200 ends. Although method 200 was described with respect to server1 and server2 for the purpose of illustration only, access may relate to any server(s) 150 in network 160. Depending on the embodiment, method 200 or any part thereof may occur one or more times. For instance, in some embodiments stages 204 to 212 may be repeated each time a (newly established or updated) policy is indicated. Stage 216 to 229 may be repeated each time a device 140 associated with an authorized user may attempt to join secured network 160. Stages 232 and 238 may be repeated each time a server tries to directly access another server. Stages 240 to 246 may be repeated each time a server tries to access another server via a gateway. Stages 250 to 252 may be repeated each time a device 160 associated with a user not authorized for secured network 150 attempts to access a server at least partly via an unsecured network.

Alternatively to the embodiments illustrated and described with respect to method 200, stages which are illustrated or described as being executed sequentially may in some other embodiments be executed in parallel or stages illustrated or described as being executed in parallel may in some other embodiments be executed sequentially. Alternatively to the embodiments illustrated and described with reference to method in 200, method 200 may in some other embodiments include more, fewer or different stages than illustrated or described. Alternatively to the embodiments illustrated and described with respect to method 200, stages may in some other embodiments be executed in a different order than illustrated or described.

FIG. 3 illustrates an abstraction module relating to access control, in accordance with some embodiments of the presently disclosed subject matter.

As shown in FIG. 3, entities may include user entities 310, server entities 320, IP address entities 330, compound entities 340, etc.

User entities 310 may include various users 312 (also referred to as entityuser), and various user groups such as user-roles 314 (also referred to as entityuserrole), all users 316, etc. Any user 312 may be included in one or more user roles 314. Examples of a user role may include administrator, support engineer, databases administrator, etc.

Server entities 320 may include various servers 322 (also referred to as entityserver), and various server groups such as server roles 324 (also referred to as entityserverrole), all servers 326, etc. Any server 322 may be included in one or more server roles 324. Examples of a server role may include webserver, application server, database server, etc.

IP address entities 330 may include various IP addresses 332 (also referred to as entityIP), and various IP address groups such as one or more groups 334 each with a plurality of IP addresses (e.g. set of IP addresses, IP address subnet (also referred to as entitysubnet), etc), all IP addresses 336, etc. Any IP address may be a public IP address, a private IP address, or an overlay IP address, depending on the embodiment.

Entities which are compound entities 340 may include any entity derived from a function of one or more entities. For instance, a compound entity may be derived by excluding an entity such as entity1 and thereby including any other entity/ies, e.g. NOT Entity1 (also referred to as entityNOT). A compound entity may be derived, for instance by combining two or more entities, e.g. Entity1 OR Entity2 (also referred to as entityOR). A compound entity may be derived for instance by taking entities which are common to two or more entities, e.g. Entity1 AND Entity2 (also referred to as entityAND). A compound entity may be derived, additionally or alternatively for instance, from a function of one or more compound entities.

As shown in FIG. 3 some possible protocols 350 which may be used within secured network 160 may include Ping, Transmission Control Protocol (TCP) port or port set, User Datagram Protocol (UDP) port or port set, Internet Protocol (IP), etc.

The subject matter is not bound by any particular type(s) of entity/ies. The subject matter is not bound by any particular protocol(s). In some embodiments, there may be a different number of entity/ies or protocol(s) than described herein. Additionally or alternatively, in some embodiments there may be one or more different type(s) of entity/ies or protocol(s) than described herein.

A protocol may be used by one entity to access another entity as represented by unidirectional arrow 352. A protocol may be used by one entity to access another entity or vice versa as represented by bidirectional arrow 354.

Referring again to method 200, when initially establishing a new policy for access control in secured network 160, in stage 204 one or more device(s) 120 may in stage 204 access management software 110 in management machine 110 and may provide any of the following: user entity/ies 310 relating to user(s) (e.g. user(s) authorized for secured network 160, user(s) approved for access from outside secured network 160), server entity/ies 320 relating to server(s) in secured network 160, IP address entity/ies 330 relating to machine(s) in secured network (e.g. gateway(s), server(s), device(s)), compound entities 340, protocol(s) 350 relating to protocols which may be used in secured network 160, etc. Additionally or alternatively, some entities or protocols may be pre-defined. For example, if a role-entity 314 or 324 is predefined, once the role(s) of the user or server is indicated, the user or server may be placed in the appropriate role entity/ies. A group such as all users 316, all servers 326, or all IP addresses 336, may for example be predefined, so that once a user, IP address or server is indicated, the user IP address or server may be placed in the corresponding all users, all IP addresses or all servers group.

Although not necessarily so, in some embodiments an access control policy may be indicated by using management software to select appropriate entities, protocols, etc., for instance as will be described now with reference to FIG. 4.

Refer to FIG. 4 which illustrates a graphical representation of a policy relating to access control, in accordance with some embodiments of the presently disclosed subject matter.

Regarding any IP address, the policy as illustrated in FIG. 4 may mean that any IP address may Hypertext Transfer Protocol (HTTP) any web-server. This part of the policy may be indicated, for instance, by selecting any IP address 336, HTTP protocol from protocols 350, unidirectional arrow 352, and server-role group 324 corresponding to webservers.

Regarding (client) administrators, the policy as illustrated in FIG. 4 may mean that any administrator may Secure Shell (SSH) or Ping any webserver, or application server, or database server. This part of the policy may be indicated for instance by selecting user-role 314 corresponding to administrators, Ping protocol 356 and SSH protocol from protocols 350, unidirectional arrow 352, and server-role 324 corresponding to webservers, server-role 324 corresponding to application servers, and server-role 324 corresponding to database servers (or by selecting a compound entity which combines webservers, application servers and database servers instead of selecting the various server roles).

Regarding support engineers, the policy as illustrated in FIG. 4 may mean that any support engineer may Remote Method Invocation (RMI) any application server. This part of the policy may be indicated for instance by selecting user role 314 corresponding to support engineers, RMI protocol from protocols 350, unidirectional arrow 352, and server-role 324 corresponding to application servers.

Regarding database administrators, the policy as illustrated in FIG. 4 may mean that any database administrator (DBA) may perform an SQL operation using a Structured Query Language (SQL) protocol to any database server. For example, an SQL operation may include a TCP port 1433 communicating with a Microsoft SQL server, or a TCP port 2483 or 2484 communicating with an Oracle SQL database. This part of the policy may be indicated for instance by selecting user role 314 corresponding to data base administrators, SQL protocol from protocols 350, unidirectional arrow 352, and server-role 324 corresponding to database servers.

Regarding application servers and database servers, the policy as illustrated in FIG. 4 may mean that any application server may SQL any database server. This part of the policy may be indicated for instance by selecting server-role 324 corresponding to application servers, SQL protocol from protocols 350, unidirectional arrow 352, and server-role 324 corresponding to database servers.

Regarding web-servers and application servers, the policy as illustrated in FIG. 4 means that any webserver may RMI any application server or vice versa. This part of the policy may be indicated for instance by selecting server-role 324 corresponding to web servers, RMI protocol from protocols 350, bidirectional arrow 354, and server-role 324 corresponding to application servers.

It should be understood that the policy shown in FIG. 4 is not binding, and that in other embodiments, the policy may be slightly or substantially different than what is illustrated and described herein.

It should also be understood that indication of policy may be performed in any appropriate manner and that the subject matter is not bound by indication by selection.

After an access control policy has been initially established, the policy may be updated. Referring again to method 200, in stage 204 one or more device(s) 120 may access management software 110 in management machine 110 in order to update policy. For instance, authorized users 312 may be added or removed, authorized users 312 may be added or removed from user-roles 314 (e.g. due to changed roles), servers 322 may be added or removed, connection(s) between server(s) or gateways may be added, removed or changed, characteristic(s) of connection(s) may be changed, networking characteristic(s) of server(s) or gateway(s) may be changed, servers may be added or removed from server-roles 324, IP addresses may be added or removed, IP addresses may be added or removed from IP address groups, protocols 350 may be added or removed, compound entities 340 may be added or removed, additional, fewer, or different type(s) of access allowable under access control may be indicated, other change(s) which may affect policy may be indicated, etc.

Although not necessarily so, in some embodiments, a newly established or updated policy may be securely distributed to one or more server(s) or gateway(s) as described above with reference to stage 208 or 220 of method 200.

Although not necessarily so, in some embodiments a policy may be provided by management machine 110 as a high level description to one or more server(s) 150 and gateway(s) 130. For instance, a high level description of the policy illustrated in FIG. 4 may include “ANY can HTTP webservers. SupportEngineers can RMI AppServers. DBAs can SQL DbServers. Administrators can (SSH, Ping) (Webservers OR AppServers OR DbServers). Webservers can mutually RMI with AppServers. AppServers can SQL DbServers.” However, the subject matter is not bound by any particular format or content for a description. In embodiments where a high level description is provided, a server 150 or gateway 130 may be able to translate a high level description (e.g. into IP address(es)) because of the server or gateway's knowledge of secured network 160. For example, the knowledge may be at least partly based on data provided to the server or gateway by management machine 110. Once a high level description of a policy is received by a server 150 or gateway 130, the server 150 or gateway 130 may determine what each entity (specified in the policy) includes in terms of IP address(es), for instance because a corresponding firewall 155 or 135 may operate based on IP address(es).

It will also be understood that the subject matter contemplates that a system or part of a system disclosed herein may be, at least partly for example, a suitably programmed machine. Likewise, the subject matter contemplates, for example, a computer program being readable by a machine for executing a method or part of a method disclosed herein. Further contemplated by the subject matter, for example, is a machine-readable medium tangibly embodying program code readable by a machine for executing a method or part of a method disclosed herein.

While embodiments of the presently disclosed subject matter have been shown and described, the subject matter is not thus limited. Numerous modifications, changes and improvements within the scope of the subject matter will now occur to the reader.

APPENDIX
Note, the algorithm that calculates a set of IPs given an entity of a high-level policy description,
is described at the end. IP stands for IP address*/
calculateServerRules
/* The following defines a method of calculating the server firewall rules, including those rules
for traffic with external entity nodes, for traffic with other server nodes, and for traffic being
routed by the gateway. */

| • | For each policy relating to a server | |
|---|---|---|
| | ∘ | Calculate ipSetA to be all IPs relating to the 1^{st} entity of the policy |
| | ∘ | Calculate ipSetB to be all IPs relating to the 2^{nd} entity of the policy |
| | ∘ | If the server's IPs are part of ipSetA |

| | |
|---|---|
| ▪ | Create rules relating to the related server's IPs and IPs in ipSetB allowing |
| | requested protocol to be used in the appropriate direction. |
| ▪ | Create rules relating to the related server's (e.g. overlay) IP and all the |
| | gateways (e.g. overlay) IPs allowing requested protocol to be used in the |
| | appropriate direction. Such rules relate to traffic being routed via the |
| | gateway. |

| | |
|---|---|
| ∘ | If the server's IPs are part of ipSetB |

| | |
|---|---|
| ▪ | Create rules using symmetrical logic to the above. |

| | |
|---|---|
| • | Respond with all created rules |

calculateGatewayRules
/* The following defines a method of calculating the gateway rules, among those the rules for
traffic routing from servers to servers over the secured network, and for traffic being routed from
authorized user devices. */

| • | For each policy | |
|---|---|---|
| | ∘ | Calculate ipSetA to be all IPs relating to the 1^{st} entity of the policy |
| | ∘ | Calculate ipSetB to be all IPs relating to the 2^{nd} entity of the policy |
| | ∘ | Create forwarding rules allowing traffic to be routed by the gateway between |
| | | (ipSetA∩overlayIPs) and (ipSetB∩overlayIPs) with the appropriate protocol and |
| | | appropriate direction. |
| | ∘ | If ipSetA contains loggedUsersOverlayIPs |

| | |
|---|---|
| ▪ | Create forwarding rules between (ipSetA ∩ loggedUsersOverlayIPs) and |
| | ipSetB with the appropriate protocol and appropriate direction. |

| | |
|---|---|
| ∘ | If ipSetB contains loggedUsersOverlayIPs |

| | |
|---|---|
| ▪ | Create forwarding rules using symmetrical logic to the above. |

| | |
|---|---|
| • | Respond with all created rules |

calculateIPsFromEntity
/* The following defines a recursive method for calculating the IPs related to a certain entity in a
high-level policy description */

| • | If the entity is of type EntityAND, EntityOR, or EntityNOT | |
|---|---|---|
| | ∘ | Recursively calculate the relevant sub-entities and combine the set as follow: |

| | |
|---|---|
| ▪ | For an EntityOR, respond with a union of the sub-sets, as A ∪ B. |
| ▪ | For an EntityAND, respond with an intersection of the set-sets, as A ∩ B. |
| ▪ | For an EntityNOT, respond with all possible IPs that are not part of the |
| | sub-set. |

| • | If the entity is of type EntityIP or EntitySubnet | |
|---|---|---|
| | ∘ | Respond with the requested IP or whole set of IPs relating to the requested subnet. |
| • | If the entity is of type EntityServer or EntityServerRole | |
| | ∘ | Respond with all IPs relating to the server or all servers with the requested role. |
| • | If the entity is of type EntityUser or EntityUserRole | |
| | ∘ | Respond with all (e.g. overlay) IPs that were assigned to all devices which are |
| | | authorized by the requested user or users with the requested role |

1. A method of controlling access in a secured network, comprising:
accessing management software on a management machine and indicating a policy which at least includes a first entity being allowed to access a second entity, by way of at least one protocol via said secured network;
thereby enabling said management machine to provide said policy to at least one machine in said secured network, and at least one of said at least one machine to translate said policy into at least one firewall rule to control access in said secured network.

2. The method of claim 1, wherein said policy at least also includes an entity being allowed to access another entity at least partly via an unsecured network.

3. The method of claim 1, wherein said management software is provided as a service in a cloud environment.

4. The method of claim 1, wherein said method enables provisioning of at least one of:
broad network access or on-demand self service to a user associated with said device.

5. The method of claim 1, wherein said secured network in an overlay network in a cloud environment.

6. A method of controlling access in a secured network, comprising:
providing a policy which at least includes a first entity being allowed to access a second entity, by way of at least one protocol via said secured network, to at least one machine in said secured network;
thereby enabling at least one of said at least one machine to translate said policy into at least one firewall rule to control access in said secured network.

7. The method of claim 6, wherein said policy also at least includes an entity being allowed to access another entity at least partly via an unsecured network.

8. The method of claim 6, wherein said second entity includes at least one server provided by a cloud provider.

9. The method of claim 6, wherein said first entity includes at least one user and wherein said policy is at least provided to a gateway by way of which at least one device associated with at least one user included in said first entity is allowed to access at least one server included in said second entity.

10. The method of claim 6, wherein said first entity includes at least one server, and wherein said policy is at least provided to at least one gateway by way of which at least one server included in the first entity is allowed to access at least one server included in the second entity.

11. The method of claim 6, wherein said first entity includes at least one server, and wherein said policy is at least provided to at least one server included in the second entity.

12. The method of claim 6, wherein said secured network includes a plurality of machines with respective firewalls.

13. A method of controlling access in a secured network, comprising:
receiving a policy relating to access control in the secured network;
translating said policy into at least one firewall rule; and
allowing or not allowing access via said secured network by a device associated with a user authorized for the secured network, or by a server, based on said at least one firewall rule.

14. The method of claim 13, wherein said policy relates to access from outside the secured network, the method further comprising:
when a device associated with a user not authorized for the secured network attempts access to a server at least partly via an unsecured network, allowing or not allowing access based on said at least one firewall rule.

15. The method of claim 13, wherein said translating said policy into at least one firewall rule applicable for a particular user is performed by a gateway when a device associated with said user accesses the gateway.

16. A method of controlling access in a secured network, comprising:
a device associated with a user accessing a gateway in said secured network;
thereby causing said gateway to translate a policy applicable to said user into at least one firewall rule and to allow or not allow access to one or more servers in said secured network based on said at least one firewall rule.

17. The method of claim 16, wherein at least one of said one or more servers is provided by at least one cloud provider, and wherein said method enables provisioning of at least one of: broad network access or on-demand self service to said user.

18. A system for controlling access in a secured network, comprising a device capable of accessing management software on a management machine and indicating a policy which at least includes a first entity being allowed to access a second entity, by way of at least one protocol via said secured network;
thereby enabling said management machine to provide said policy to at least one machine in said secured network, and at least one of said at least one machine to translate said policy into at least one firewall rule to control access in said secured network.

19. A system for controlling access in a secured network, comprising a management machine capable of providing a policy which at least includes a first entity being allowed to access a second entity, by way of at least one protocol via said secured network, to at least one machine in said secured network; thereby enabling at least one of said at least one machine to translate said policy into at least one firewall rule to control access in said secured network.

20. A system for controlling access in a secured network, said system comprising a gateway or server capable of:
receiving a policy relating to access control in the secured network; translating said policy into at least one firewall rule; and
allowing or not allowing access via said secured network by a device associated with a user authorized for the secured network, or by a server, based on said at least one firewall rule.

21. A system for controlling access in a secured network, comprising a device associated with a user capable of accessing a gateway in said secured network;
thereby causing said gateway to translate a policy applicable to said user into at least one firewall rule and to allow or not allow access to one or more servers in said secured network based on said at least one firewall rule.

22. A computer program product comprising a machine useable medium having machine readable program code embodied therein for controlling access in a secured network, the computer program product comprising:
machine readable program code for causing a machine to access management software on a management machine and to indicate a policy which at least includes a first entity being allowed to access a second entity, by way of at least one protocol via said secured network;
thereby enabling said management machine to provide said policy to at least one machine in said secured network, and at least one of said at least one machine to translate said policy into at least one firewall rule to control access in said secured network.

23. A computer program product comprising a machine useable medium having machine readable program code embodied therein for controlling access in a secured network, the computer program product comprising:
machine readable program code for causing a machine to provide a policy which at least includes a first entity being allowed to access a second entity, by way of at least one protocol via said secured network, to at least one machine in said secured network;
thereby enabling at least one of said at least one machine to translate said policy into at least one firewall rule to control access in said secured network.

24. A computer program product comprising a machine useable medium having machine readable program code embodied therein for controlling access in a secured network, the computer program product comprising:
machine readable program code for causing a machine to receive a policy relating to access control in the secured network;
machine readable program code for causing the machine to translate said policy into at least one firewall rule; and
machine readable program code for causing the machine to allow or not allow access via said secured network by a device associated with a user authorized for the secured network, or by a server, based on said at least one firewall rule.

25. A computer program product comprising a machine useable medium having machine readable program code embodied therein for controlling access in a secured network, the computer program product comprising:
machine readable program code for causing a machine associated with a user to access a gateway in said secured network;
thereby causing said gateway to translate a policy applicable to said user into at least one firewall rule and to allow or not allow access to one or more servers in said secured network based on said at least one firewall rule.
